(19) United States
(12) Patent Application Publication
(10) Pub. No.: US 2015/0333566 A1
(43) Pub. Date: Nov. 19, 2015

(54) A SYSTEM AND METHOD FOR VOLTAGE REGULATION IN A VOLTAGE SUPPLY

(71) Applicant: Olivier Berard, Voreppe (FR)

(72) Inventor: Olivier Berard, Voreppe (FR)

(73) Assignee: Schneider Electric IT Corporation, West Kingston, RI (US)

(21) Appl. No.: 14/427,003

(22) PCT Filed: Sep. 12, 2012
(86) PCT No.: PCT/IB2012/002166

§ 371 Date: Jul. 10, 2015

(51) Int. Cl. H02J 9/06

(52) U.S. Cl. CPC H02J 9/06

(57) ABSTRACT

Disclosed is an uninterruptable power supply comprising a switchable input power converter having an input operable to receive a supply power network voltage, the power network voltage being subject to fluctuations which may give rise to a disturbance to any load connected to the power network; and a voltage regulation circuit for controlling the switchable input power converter, thereby regulating its output. The voltage regulation circuit senses the power network voltage; and causes the uninterruptable power supply to generate from the sensed power network voltage a compensatory reactive current indicative of the voltage fluctuations on the power network voltage. The compensatory reactive current is used to compensate for the voltage fluctuations on the power network voltage.

### FIELD OF THE INVENTION

The present invention relates to uninterruptible power supplies (UPS) and in particular to an uninterruptible power supply operable to regulate voltage in a voltage supply, and methods of regulating voltage in a voltage supply using such a UPS.

### BACKGROUND OF THE INVENTION

An uninterruptible power supply (UPS) may be used to provide emergency power in situations where the main power supply fails or performs in an unusual manner. The UPS is designed to switch over with a minimal delay, due to the nature of the batteries used and the circuitry of the UPS. A UPS can be used to deal with a number of unusual events occurring at the main power supply, such as: power failure; surge; sag; spikes; noise; frequency instability; harmonic distortion; etc.

A UPS can be used to protect any type of equipment, however, generally a UPS is most often found in computers, data centers, telecommunication systems, and any other electrical equipment which may cause serious consequences such as damage to a person or to a business interest if power were to fail.

A UPS can take many different forms and relates to various different technologies. The most common general categories of UPS are online, line interactive, and standby. Each of these is well-known in the art as are the other alternatives such as hybrid topologies and ferro-resonant technologies.

One of the main requirements of operating a UPS is to ensure that the power supply that is supplied to the load has a good voltage quality with relatively little harmonic distortion. The load is any system that is provided with the power from the UPS.

Until recently, power supplies have tended to come from large generating stations which cover large regions of territory. A number of generating stations may be interconnected by means of a grid to provide power wherever it is required. The fact that the power has been generated in large generating stations means that voltage stability is generally relatively consistent. This means that anywhere throughout the grid, the quality of the power supply will be similar despite the fact that the location may be distant from the power station.

As time passes, large power stations are being replaced and/or augmented with different sources of power. The previous fixed system of large power supplies and a simple grid is being replaced by distributed power grids which distribute power from a variety of different types of power sources. These types of power sources include distributed power sources and green power sources including photovoltaic power, wind turbines, etc.

These new types of local power sources are generally low power sources which are connected together through the grid and may be located in many different locations. As a result, it is increasingly likely that a local power source will provide the power to operate a UPS in many situations.

The local power sources tend to be less stable than the generating stations and the production of energy is impacted by various factors such as climate conditions, etc. This can cause voltage variations on the load being supplied, dependent on the various factors.

In order to compensate for some of the problems associated with local power sources, shunt reactive compensators (also called STATCOM) are used to regulate the local grid voltage. These compensators are able to increase or decrease local voltage to maintain a near constant or nominal value.

Not all local grid voltages are protected by means of shunt reactive compensation. In addition, some UPS systems are particularly sensitive to fluctuating voltages. If these types of UPS systems are used in areas where there are no shunt reactive compensation provisions, the operation of the UPS may be subject to instability and to problems in protecting the ultimate load.

Active filters have been used to generate reactive power using a current sensor or by using information coming from the load. However, this does not offer adequate protection to a load or any backup facilities.

A need exists to ensure that all power converters and UPSs have the ability to compensate for any voltage fluctuations received from the local grid or other sources of power.

### Objects Of The Invention

It is an object of the present invention to overcome at least some of the problems associated with the prior art.

It is a further object of the present invention to provide an uninterruptable power supply and method for operating the same, which can compensate for instability in the voltage supplied thereto.

### SUMMARY OF THE INVENTION

The present invention provides a method and system as set out in the accompanying claims.

### BRIEF DESCRIPTION OF THE DRAWINGS

Reference will now be made, by way of example, to the accompanying drawings, in which:

FIG. 1 is a block diagram of a UPS in a distributed power grid environment, in accordance with an embodiment of the invention,

FIG. 2 is a block diagram of a simplified representation of FIG. 1, in accordance with an embodiment of the invention,

FIG. 3 is a simplified diagram of a first Fresnel diagram, in accordance with an embodiment of the invention,

FIG. 4 is a simplified diagram of a second Fresnel diagram, in accordance with an embodiment of the invention,

FIG. 5 is a circuit diagram of a reversible switching converter, in accordance with the prior art,

FIG. 6 is a circuit diagram of an input converter control circuit, in accordance with the prior art,

FIG. 7 is a circuit diagram of a further input converter control circuit, in accordance with an embodiment of the invention,

FIG. 8 is a graph showing the different operating modes of the reactive controller, in accordance with an embodiment of the invention,

FIGS. 9 is a circuit diagram of an operational example of the present invention, in accordance with an embodiment of the invention.

### DETAILED DESCRIPTION OF THE PREFERRED EMBODIMENTS

The present invention relates to a UPS which can be connected to a distributed power grid or to a grid with high impedance and includes a grid voltage controller, either as part of the UPS or integrated with the UPS during installation. A reversible UPS may also make use of the grid connected input converter for other functions as well as for stabilizing fluctuating voltage supplies.

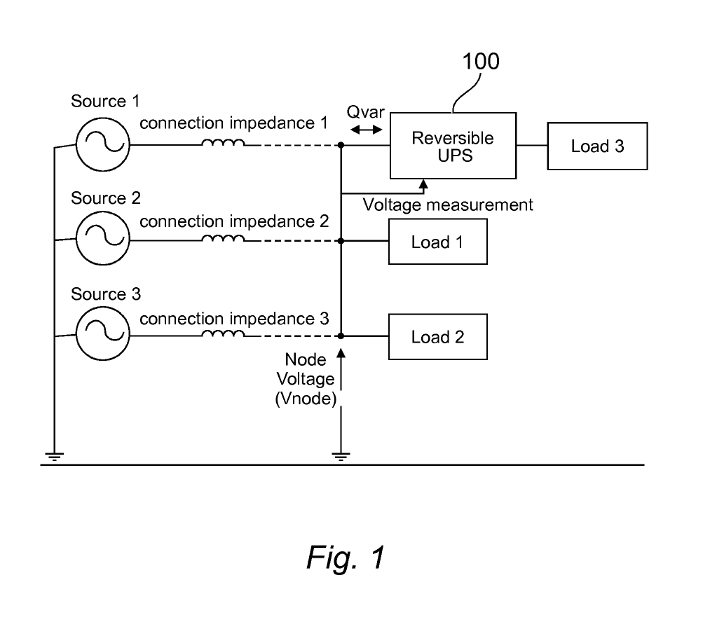

FIG. 1 shows a schematic representation of a distributed power grid configuration. Energy is provided by different sources (Source 1, Source 2, and Source 3), each having a connection impedance (connection impedance 1, connection impedance 2, and connection impedance 3), to the loads (Load 1, Load 2, and Load 3). The sources could be respectively wind turbines, photovoltaic-based sources, etc.

The sources are all connected via a single node to the different loads respectively: Load 1, Load 2 and a reversible UPS 100. Load 3 is supplied and protected by the reversible UPS 100.

A conventional UPS typically only monitors active current and adjusts therefor. However, the current drawn by Load 1 and Load 2 through their connection impedances causes a reactive power flow. The UPS 100 according to the embodiments herein is able to generate or absorb controlled reactive power, using its input converter connected to the sources, thereby mitigating this reactive flow generated by Load 1 and Load 2. Reactive power Qvar is the reactive power flow resultant from that of loads 1 and 2 and that of the UPS (but not from load 3 whose reactive power is isolated by the UPS).

The UPS 100 also obtains a measurement of an input voltage (Vnode) on the circuit. It can use this voltage measurement to control the reactive power Qvar and keep it within acceptable limits. Reactive power control using a local voltage sensing is advantageous compared to direct measurement of the reactive current at each of the attached loads (here Load 1 and Load 2). There may be large distances between the loads and the UPS. Also, when current sensors are required increasing complexity and cost.

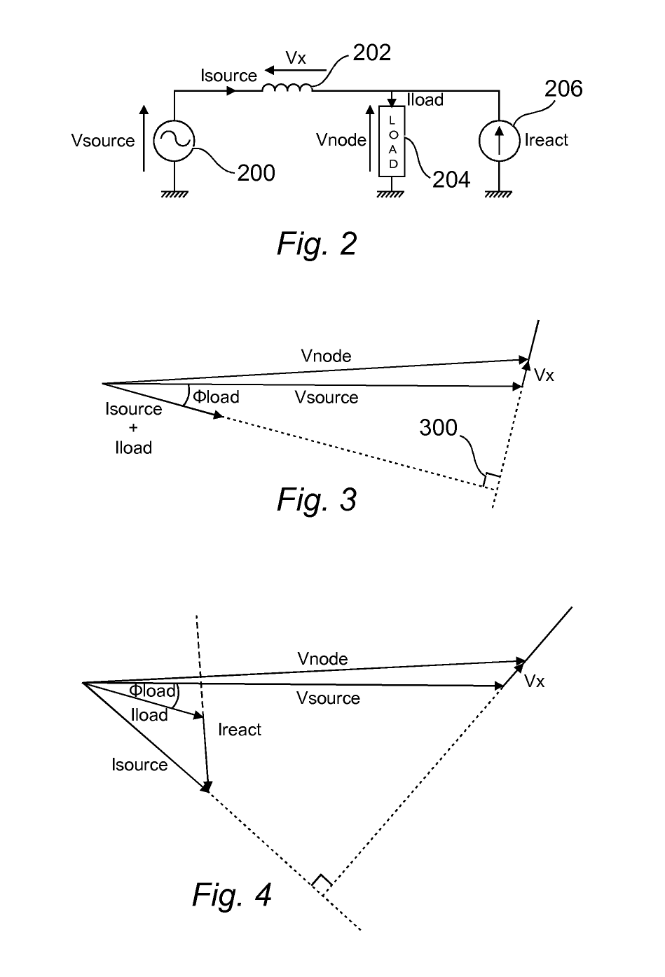

FIG. 1 can be simplified and represented as shown in FIG. 2.

In FIG. 2, the multiple sources of FIG. 1 are replaced by a single source 200 with an associated connection impedance 202. Loads 1 and 2 in FIG. 2 are replaced by a single load 204, and the reversible UPS is considered as a reactive current source 206. The simplified representation in FIG. 2 is used to explain how reactive compensation is able to control node voltage (Vnode). The FIG. 2 circuit representation can be used to create Fresnel diagrams relating to voltage and current. A Fresnel diagram essentially enables a modulated signal to be represented as a vector. The source voltage (Vsource) is taken as the phase reference. The node voltage (Vnode) will be different from the source voltage due to connection impedance 202.

In FIG. 3, the reactive current given by the UPS is essentially zero, which means that Isource =Iload. The load is here considered to be a resistive impedance load. The current (Isource) is leading the load voltage (Vsource). The voltage on the connection impedance (Vx) is shifted by 90° (angle 300) relative to the source current (Isource).

In FIG. 4, the reactive current (Ireact) produced by the UPS is negative. Thus, in this case, the current Isource is equal to the sum of Iload and Ireact. This gives rise to a change in the phase angle and the amplitude of the connection impedance voltage (Vx), leading to a higher node voltage (Vnode) value. This is demonstrated by the vectors representing the voltages Vx and Vnode.

Similarly, if the reactive current (Ireact) produced by the UPS current is positive, this will lead to a lower node voltage Vnode, although this is not shown.

The node voltage (Vnode) could be defined with respect to the reactive current (Ireact) by the following equation:

$$Vnode = Iload \cdot Zload = ( Isource - Ireact ) \cdot Zload$$

$$Vnode = ( \frac{Vsource - Vnode}{Zx} - Ireact ) \cdot Zload$$

$$Vnode ( \frac{Zx + Zload}{Zx} ) = ( \frac{Vs}{Zx} - Ireact ) \cdot Zload$$

$$Vnode = \frac{Zload}{Zx + Zload} \cdot ( Vs - Ireact \cdot Zx )$$

where Zload is the impedance of the load and Zx is the impedance of the connection.

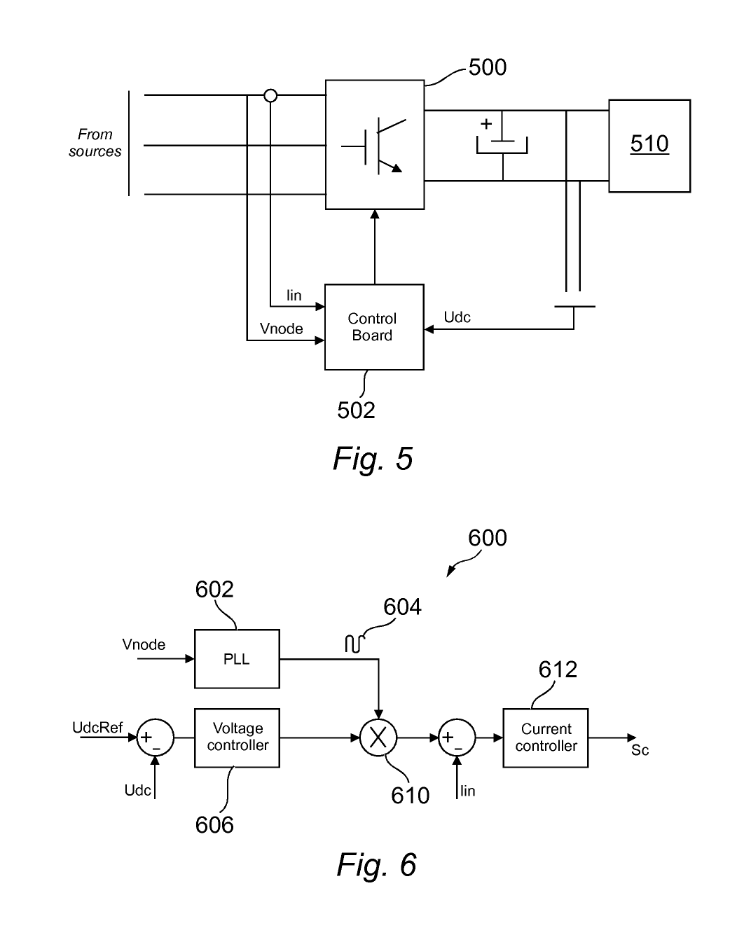

The typical UPS input structure is represented in FIGS. 5 and 6 which show a reversible switching converter 500 driven by a control board 502, which generates switch commands Sc based on a measurement of the input current Iin, input voltage Vnode and the UPS internal DC voltage Udc; and on the defined objectives of the system.

The objectives for the UPS input control include: maintaining a fixed output voltage Udc so as to supply an output stage, which typically is connected to an inverter 510, irrespective of the power demands from the inverter; and extracting from the input source a limited sine current wave form which is synchronized with the input voltage (Vnode). Input current Iin is a current composed of reactive current Ireact and an active current used to supply the load.

To achieve these objectives, the control circuit 600 of FIG. 6 may be used. This circuit includes a Phase Lock Loop (PLL) 602, which is used to generate a periodic reference waveform, such as a sinusoidal reference waveform (sine waveform) 604 which is synchronized with the input voltage (Vnode). The circuit further includes a DC voltage controller 606 which can calculate the Udc voltage error from a comparison of Udc and Udcref to generate an appropriate current reference Ir. Udcref is a reference voltage generated on the control board. Multiplier 610 combines the current reference with the sine waveform to produce a sine reference current. The difference of the input current Iin and reactive current Ireact is obtained and used to define a current error which the current controller 612 will try to suppress. The current controller 612 is then used to generate appropriated switching commands Sc for the reversible switching converter 500 which follows the sine current reference produced by the multiplier 610.

This circuit is a typical circuit used to control UPS active input current, and the internal voltage Udc of the UPS. It does not, however, in this form, provide any control of the Vnode voltage or the reactive input current Ireact. This is because the magnitude of the current reference is dependent only on UPS internal voltage Udc.

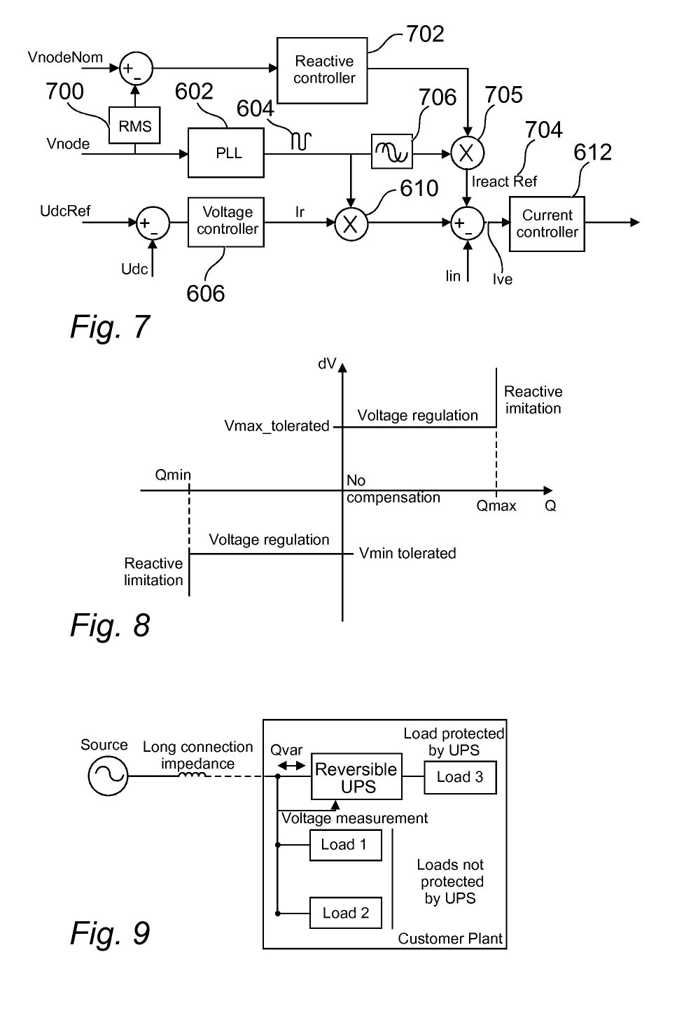

The FIG. 7 circuit adds functionality to the FIG. 6 circuit that enables the FIG. 7 circuit to stabilize at least some of the unstable power supply voltage. The circuit of FIG. 7 is similar to FIG. 6, and like components (those with the same labels) operate as described in relation to that Figure. However, in FIG. 7 an additional current variable (Ireactref 704) is provided based upon variations of the voltage Vnode. This is added to or subtracted from the sinusoidal current reference to compensate for the reactive current Ireact caused by the connection impediances and other loads on the network, thereby minimising voltage fluctuations of the voltage Vnode.

The circuit of this embodiment comprises an additional controller 702. This controller is referred to as a reactive or voltage controller and is used to measure voltage fluctuations in the voltage supply Vnode. As a result, the final or modified switching current for the switching converter is varied to take into account the voltage supply changes.

Here, a statistical measure, such as a root mean square (RMS), of a node voltage 700 is compared to a nominal voltage value VnodeNom. The nominal voltage value is a fixed reference voltage generated by the control board based on user requirements. The voltage difference is used by a reactive controller 702 to generate a peak current reference. This peak current reference is multiplied by the sine waveform shifted by 90° using phase shifter 706 to produce a reactive current reference (Ireact Ref) 704 in phase with the reactive current Ireact, which is a component of input current Iin. The current reference Ireact Ref 704 is essentially a current variable which can be added to or subtracted from the sine current reference to take into account any voltage fluctuations in the supply. The reactive current reference is then added to the sine current reference, and current measurement Iin is subtracted from the result to produce a variable current error Ive. The current controller 612 then generates the switching commands Sc based on variable current error Ive.

The capability of the UPS input to monitor the input voltage will depend on the maximum power capability of the power switching converter.

Referring to the graph in FIG. 8, the operating mode of the reactive controller of FIG. 7 will now be described. The term dV is the deviation of node voltage compared to the nominal voltage. If dV is in the range Vmax_tolerated and Vmin_tolerated, no reactive current will be generated by the UPS, because the voltage deviation is within a range that can be tolerated. If dV is over Vmax_tolerated or under Vmin_tolerated, the reactive controller is enabled and generates a reactive current in order to maintain the input voltage within the range of Vmax_tolerated to Vmin_tolerated.

The reactive controller is enabled by a logical condition implemented in firmware (not shown).

If the required reactive power to regulate the voltage is over the capability of the power converter (Qmax, Qmin), the reactive power is fixed at a maximum value.

Moreover, the reactive power limitation will be variable based on the UPS output power level. If the UPS is fully loaded, the reactive compensation will be relatively small. If UPS is at a low load level, the reactive compensation may be more significant.

An important function of the reactive controller is to determine the power source impedance which value is needed to enable the UPS to function correctly. Vnode can be defined as follows:

$$Vnode = \cdot ( \frac{Zload}{Zx + Zload} \cdot Vs - \frac{Zload \cdot Zx}{Zx + Zload} \cdot Ireact )$$

From the equation it can be seen that Vnode is a function of the source voltage (Vsource) and the reactive current (Ireact). If Vsource is considered as a constant, variations of Vnode are directly proportional to variations in Ireact. A simple Proportional Integral PI controller or any other appropriate controller could then be used.

The equivalent impedance of the circuit Zeq needs to be determined and depends on the system and grid design. The value of Zeq is given by:

$$Zeq = \frac{Zload \cdot Zx}{Zx + Zload}$$

The parameter Zeq can be evaluated by a learning sequence as will now be described. Vsource is considered to be constant. The derivative value of Vnode related to the derivative value of Ireact is equal to the equivalent impedance Zeq:

$$\frac{d Vnode}{d Ireact} = Zeq$$

Thus, by comparing the variation of Vnode during a sequence where smooth variation of Ireact is imposed, the equivalent impedance Zeq can be determined. From this it is possible to define the reactive controller gain to use in the voltage controller by keeping a large stability margin in case of Zload variations.

This concepts disclosed herein are intended to offer the opportunity to stabilize the supply voltage of a load directly connected to the grid, and not protected by the output of the UPS (namely Load 1 and Load 2 in FIG. 9).

The concepts disclosed herein are of further use if a load is connected to a distributed power grid with low voltage stability, or connected on a high impedance line. A simple modification of the usual UPS input control can be effected by adding to the UPS input current a controlled reactive current based on the input voltage deviation compared to nominal voltage as described above.

The invention may be incorporated into an algorithm implemented in the UPS. The algorithm may include a number of functions. A grid reactive voltage regulator is implemented in which the regulator will determine how much reactive power it must generate in order to maintain the grid voltage at a near nominal value. The voltage regulation will operate within a predetermined power range capability. Over that range, the reactive power will be limited. If the voltage exceeds a maximum or minimum level, it will be considered as out of tolerance with respect to voltage and the regulation will be stopped or reactive power will be limited.

The UPS is generally connected on its input to a power source. That power source could be a grid or another voltage source such as, for example, a diesel generator.

Even if the UPS is used to give a high quality voltage to loads connected on its output, in a local power network other loads could be connected to the same power source as the UPS input. These other loads could also be sensitive to voltage variations and may benefit from the power source voltage regulation of the present invention. Using the UPS regulation described above, the UPS input voltage is regulated for all loads connected thereto. As such, other loads may be connected to and benefit from the voltage regulation circuit of the present invention.

It will be appreciated that this invention may be varied in many different ways and still remain within the intended scope of the invention as defined in the claims

1-15. (canceled)

16. An uninterruptable power supply comprising:
a switchable input power converter having an input operable to receive a supply power network voltage, the power network voltage being subject to fluctuations which may give rise to a disturbance to any load connected to the power network; and
a voltage regulation circuit for controlling said switchable input power converter, thereby regulating its output;
wherein the voltage regulation circuit is operable to:
sense said power network voltage; and
cause said uninterruptable power supply to generate from said sensed power network voltage a compensatory reactive current indicative of the voltage fluctuations on the power network voltage, the compensatory reactive current being used to compensate for said voltage fluctuations on the power network voltage.

17. The uninterruptable power supply of claim 16, wherein the voltage regulation circuit is operable to generate a control current adapted to switch the switchable input power converter, said control current being dependent on a first reference current derived from the variation of the output of the uninterruptable power supply compared to a first fixed reference; wherein said control current is further dependent on a second reference current derived from the variation of the supply power network voltage compared to a second fixed reference.

18. The uninterruptable power supply of claim 17, wherein the voltage regulation circuit is operable to synchronize said first reference current in phase with the supply power network voltage, and to synchronize said second reference current with a signal 90 degrees out of phase with the supply power network voltage.

19. The uninterruptable power supply of claim 18, further comprising a phase locked loop for generating a synchronized sine waveform for performing said synchronizing.

20. The uninterruptable power supply of claim 17 wherein the voltage regulation circuit is operable such that said control current is obtained by subtracting the sum of the first reference current and second reference current from the input current to the uninterruptable power supply, or subtracting the input current to the uninterruptable power supply from the sum of the first reference current and second reference current.

21. The uninterruptable power supply of claim 17 being operable such that said second reference current is derived from the variation of a statistical measurement of the supply power network voltage compared to said first fixed reference.

22. The uninterruptable power supply of claim 21, wherein the statistical measurement is the root mean square value.

23. The uninterruptable power supply of claim 16 being operable to determine the power source impedance resultant from load impedances and connection impedances on the network by varying the compensatory reactive current in a controlled manner and observing the resultant variation on the supply power network voltage.

24. The uninterruptable power supply of claim 16 wherein the input converter is operable to provide an output DC voltage to an output power converter, for supplying a load;
said uninterruptable power supply further comprising a storage device operable to supply the output converter should power network voltage fall outside predetermined tolerances.

25. A method of regulating a supply power network voltage input of an uninterruptable power supply comprising the steps of:
supplying a power network voltage to said uninterruptable power supply, the power network voltage being subject to fluctuations which may give rise to a disturbance to any load connected to the power network;
sensing said power network voltage; and
controlling said uninterruptable power supply so that it generates from said sensed power network voltage a compensatory reactive current indicative of the voltage fluctuations on the power network voltage, the compensatory reactive current being used to compensate for said voltage fluctuations on the power network voltage.

26. The method of claim 25, further comprising the steps of: generating a first reference current derived from the variation of the output of the uninterruptable power supply compared to a first fixed reference; generating a second reference current derived from the variation of the supply power network voltage compared to a second fixed reference; and generating a control current for controlling the uninterruptable power supply based on said first reference current and said second reference current.

27. The method of claim 26, wherein said first reference current is synchronized in phase with the supply power network voltage, and said second reference current is synchronized 100 degrees out of phase with the supply power network voltage.

28. The method of claim 26, wherein said control current is obtained by subtracting the sum of the first reference current and second reference current from the input current to the uninterruptable power supply, or subtracting the input current to the uninterruptable power supply from the sum of the first reference current and second reference current.

29. The method of claim 26 wherein said second reference current is derived from the variation of a statistical measurement of the supply power network voltage compared to said first fixed reference.

30. The method of claim 29, wherein the statistical measurement is the root mean square value.

31. The method of claim 25 further comprising the step of determining the power source impedance resultant from load impedances and connection impedances on the network by varying the compensatory reactive current in a controlled manner and observing the resultant variation on the supply power network voltage.
